(19) United States
(12) Patent Application Publication
(10) Pub. No.: US 2025/0196546 A1
(43) Pub. Date: Jun. 19, 2025

(54) PNEUMATIC TIRE

(71) Applicant: Sumitomo Rubber Industries, Ltd., Kobe-shi (JP)

(72) Inventor: Shunsuke ITO, Kobe-shi (JP)

(73) Assignee: Sumitomo Rubber Industries, Ltd., Kobe-shi (JP)

(21) Appl. No.: 18/974,860

(22) Filed: Dec. 10, 2024

(30) Foreign Application Priority Data
Dec. 15, 2023 (JP) 2023-212335

(51) Int. Cl. B60C 15/00; B60C 13/00; B60C 15/02

(52) U.S. Cl. CPC B60C 15/0009; B60C 13/00; B60C 15/02

(57) ABSTRACT

A pneumatic tire mountable and usable on a rim can include a tread portion having a ground contact surface, and a pair of sidewall portions extending inward in a tire radial direction from both sides of the tread portion in a tire axial direction. The rim can have a rim diameter of 10 to 18 inches. The rim can have a rim width that is 78% to 99% of a cross-sectional width of the tire. A ratio of a cross-sectional height of the tire to the cross-sectional width can be 30% to 45%. Each sidewall portion can have a buttress portion located on an outer side in the tire radial direction. A protector protruding outward in the tire axial direction can be on at least one of a pair of the buttress portions.

### CROSS-REFERENCE TO RELATED APPLICATION

The present application claims priority to Japanese patent applications JP2023-212335, filed on Dec. 15, 2023, the entire contents of which are incorporated herein by reference in its entirety.

### BACKGROUND

### Field

The present disclosure relates to a pneumatic tire that is mountable for use on a rim.

### Background Art

Small-diameter pneumatic tires suitable for use on small shuttle buses and the like have conventionally been known. For example, Japanese Laid-Open Patent Publication No. 2023-102627 proposes a pneumatic tire in which a bead portion on which strain is concentrated due to the diameter being reduced has improved durability.

However, a vehicle such as a small shuttle bus typically makes frequent stops in the vicinity of a curbstone, and, for a small-diameter tire such as the pneumatic tire described in Japanese Laid-Open Patent Publication No. 2023-102627, there has been a demand for improvement in cut resistance against puncturing or damage to a wheel which may be caused by contact with a curbstone.

### SUMMARY

According to one more aspects, a pneumatic tire can include a tread portion having a ground contact surface, and a pair of sidewall portions extending inward in a tire radial direction from both sides of the tread portion in a tire axial direction. The rim can have a rim diameter RD of 10 to 18 inches. The rim can have a rim width RW that is 78% to 99% of a cross-sectional width SW of the tire. A ratio SH/SW of a cross-sectional height SH of the tire to the cross-sectional width SW can be 30% to 45%. Each of the pair of sidewall portions can have a buttress portion located on an outer side in the tire radial direction. A protector protruding outward in the tire axial direction can be disposed on at least one of a pair of the buttress portions.

### BRIEF DESCRIPTION OF THE DRAWINGS

FIG. 1 is a cross-sectional view of a pneumatic tire according to one or more embodiments of the present disclosure; and

FIG. 2 is an enlarged cross-sectional view of a sidewall portion of the tire pf FIG. 1.

### DETAILED DESCRIPTION

The present disclosure, as well as one or more embodiments of the present disclosure, has been made in view of the aforementioned circumstances in the BACKGROUND section. It can be an object of the present disclosure or one or more embodiments thereof, among one or more objects, to provide a pneumatic tire that can have improved cut resistance.

The pneumatic tire according to one or more embodiments of the present disclosure can have the herein-described configuration and therefore, can have improved cut resistance.

One or more embodiments of the present disclosure will be described below in detail with reference to the drawings.

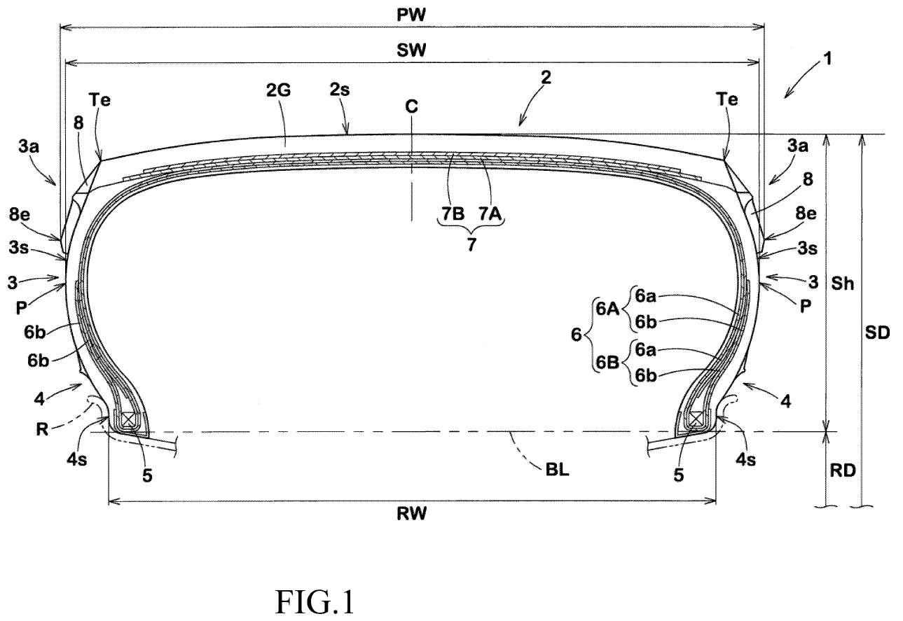

FIG. 1 is a tire meridional cross-sectional view of a pneumatic tire 1 according to one or more embodiments of the present disclosure in a standardized state. The terminology “standardized state” can refer to or be regarded as a state in which the pneumatic tire 1 is mounted on a standardized rim and adjusted to be inflated to a standardized internal pressure, and no load is applied to the pneumatic tire 1. Hereinafter, unless otherwise specified, dimensions of components of the pneumatic tire 1, etc., are represented by values measured in the standardized state.

In a case where a standard system including a standard on which the pneumatic tire 1 is based is provided, the terminology “standardized rim” can refer to a rim R that is defined by the standard for each tire, and is, for example, “standard rim” in the JATMA standard, “Design Rim” in the TRA standard, or “Measuring Rim” in the ETRTO standard. In a case where a standard system including a standard on which the pneumatic tire 1 is based is not provided, the terminology “standardized rim” can refer to a rim R having the smallest rim width RW among rims R on which the tire can be mounted, and which do not cause air leakage and have the smallest rim diameter RD.

In a case where a standard system including a standard on which the pneumatic tire 1 is based is provided, the terminology “standardized internal pressure” can refer to an air pressure that is defined by the standard for each tire, and can be “maximum air pressure” in the JATMA standard, the maximum value recited in the table “TIRE LOAD LIMITS AT VARIOUS COLD INFLATION PRESSURES” in the TRA standard, or “INFLATION PRESSURE” in the ETRTO standard, as examples. In a case where a standard system including a standard on which the pneumatic tire 1 is based is not provided, the terminology “standardized internal pressure” can refer to an air pressure defined for each tire by a manufacturer or the like.

As illustrated in FIG. 1, the pneumatic tire 1 according to one or more embodiments of the present disclosure, which can be mounted and used on the rim R, can have a small diameter, a small ground contact length, and a large ground contact width, and thus can have a so-called wide ground contact surface shape. The pneumatic tire 1 having such a structure can, for instance, allow increase in space in a vehicle and space inside the rim, and thus can allow, for example, improvement in transport efficiency, use of a large-diameter brake, and/or upsizing of an in-wheel motor, when used in a small bus, a low-floor electric vehicle, or the like.

The rim R on which the pneumatic tire 1 according to one or more embodiments of the present disclosure mounted has a rim diameter RD of 10 to 18 inches. Since the rim diameter RD can be 10 inches or more, a space can be ensured inside the rim. Since the rim diameter RD can be 18 inches or less, excessive increase in rim weight and tire weight can be inhibited, which can result in improvement in ride comfort.

According to one or more embodiments of the present disclosure, a rim width RW of the rim R can be 78% to 99% of a cross-sectional width SW of the pneumatic tire 1. Here, the rim width RW of the rim R can correspond to a width between a pair of outer surfaces 4s in the tire axial direction, which can be located on an inner side, in the tire radial direction, of the pneumatic tire 1 in the standardized state. The cross-sectional width SW can be a width in the tire axial direction between a pair of tire maximum width positions P in a profile excluding partially protruding portions of the pneumatic tire 1.

Since the rim width RW can be 78% or more of the cross-sectional width SW, a large volume of a tire inner cavity can be ensured, which can contribute to improvement in ride comfort. Since the rim width RW can be 99% or less of the cross-sectional width SW, a contribution to bearing a heavy load of a small bus, a low-floor electric vehicle, or the like, can be made.

In the pneumatic tire 1 according to one or more embodiments of the present disclosure, a ratio SH/SW of a cross-sectional height SH of the tire to the cross-sectional width SW can be 30% to 45%. Here, the cross-sectional height SH of the tire can be a height in the tire radial direction from a bead base line BL to a tire equator C. The bead base line BL can be regarded as an imaginary line corresponding to the rim diameter RD of the rim R. The ratio SH/SW can be regarded or referred to as a value commonly known as an aspect ratio.

Since the ratio SH/SW can be 30% or more, a large volume of the tire inner cavity can be ensured, which can result in improvement in ride comfort. Since the ratio SH/SW can be 45% or less, excessive increase in an outer diameter SD of the tire can be inhibited, which can contribute to increase in space in a vehicle such as a small bus or a low-floor electric vehicle.

The pneumatic tire 1 according to one or more embodiments of the present disclosure can include a tread portion 2 having a ground contact surface 2s, and a pair of sidewall portions 3 extending inward in the tire radial direction from both sides of the tread portion 2 in the tire axial direction. According to one or more embodiments of the present disclosure, the pair of sidewall portions 3 can each have a buttress portion 3a located on an outer side in the tire radial direction.

The pneumatic tire 1, according to one or more embodiments, can include bead portions 4 located inward of the pair of sidewall portions 3, respectively, in the tire radial direction. Here, the outer surface 4s, in the tire axial direction, which is located on the inner side of the pneumatic tire 1 in the tire radial direction, can be regarded as an outer surface 4s of the bead portion 4 in the tire axial direction.

Each of the bead portions 4 can have a ring-shaped bead core 5 extending in the tire circumferential direction, for example. The bead core 5 is, for example, formed of a steel wire. The pneumatic tire 1 can include a carcass 6 extending from the tread portion 2 to the pair of bead portions 4, and a belt layer 7 provided in the tread portion 2.

According to one or more embodiments of the present disclosure, a protector 8, which can protrude outward in the tire axial direction, can be disposed in at least one of the pair of buttress portions 3a. The protector 8 can partially protrude outward in the tire axial direction from an outer surface 3s that forms a profile of the sidewall portion 3 having the buttress portion 3a, for example. The protector 8 can be provided at least on the outer surface 3s, which can be disposed on the outer side of a vehicle when the pneumatic tire 1 is mounted on the vehicle.

In the buttress portion 3a having such a structure, when the pneumatic tire 1 approaches a curbstone, the protector 8 can be brought into contact with the curbstone, which can inhibit the outer surface 3s of the sidewall portion 3 and the rim R from coming into contact with the curbstone. In addition, since the protector 8 can be provided on the buttress portion 3a, even when a curbstone is low, contact between the outer surface 3s and the curbstone can be reliably reduced or prevented. Therefore, the pneumatic tire 1 according to one or more embodiments of the present disclosure can have improved cut resistance.

According to one or more embodiments, the protector 8 can be provided on each of the pair of buttress portions 3a. For the pneumatic tire 1 having such a structure, puncturing and damage to a wheel due to contact with a curbstone can be reduced irrespective of the mounting direction to the rim R. In a case where a tread pattern formed in the ground contact surface 2s is an asymmetric pattern for which a tire mounting direction to a vehicle is designated, the protector 8 can be provided merely on the buttress portion 3a to be located on the outer side of the vehicle.

According to one or more embodiments of the present disclosure, the protector 8 can have an outer end 8e that is located outward, in the tire axial direction, of the tire maximum width position P on the outer surface 3s of the sidewall portion 3 excluding the protector 8. The protector 8 having such a structure can reliably reduce contact between a curbstone and the sidewall portion 3.

A total width PW of the pneumatic tire 1 can be a width in the tire axial direction between a pair of the outer ends 8e, and the total width PW, according to one or more embodiments of the present disclosure, can be 105% to 115% of the cross-sectional width SW. Since the total width PW can be 105% or more of the cross-sectional width SW, for instance, contact between a curbstone and the sidewall portion 3 can be reliably reduced, which can result in improvement in cut resistance of the pneumatic tire 1. Since the total width PW can be 115% or less of the cross-sectional width SW, for instance, excessive increase in side stiffness can be inhibited, which can achieve both cut resistance and ride comfort for the pneumatic tire 1.

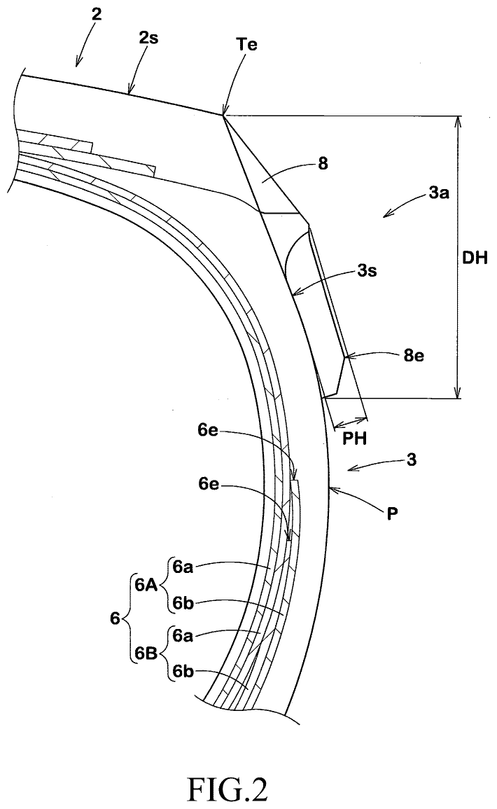

FIG. 2 is an enlarged cross-sectional view of the sidewall portion 3 of FIG. 1. As illustrated in FIGS. 1 and 2, a protrusion height PH of the protector 8 can be 2.0 to 6.0 mm, as an example. Since the protrusion height PH can be 2.0 mm or more, for instance, contact between a curbstone and the sidewall portion 3 can be reliably reduced, which can result in improvement in cut resistance of the pneumatic tire 1. Since the protrusion height PH can be 6.0 mm or less, for instance, excessive increase in side stiffness can be inhibited, which can achieve both cut resistance and ride comfort for the pneumatic tire 1.

According to one or more embodiments of the present disclosure, the tread portion 2 can include tread rubber 2G that forms the ground contact surface 2s. The ground contact surface 2s can have a pair of tread ends Te on both sides in the tire axial direction. Here, the pair of tread ends Te can each be an outermost ground contact position, in the tire axial direction, of the pneumatic tire 1 which is in contact with a plane at a camber angle of 0° with 70% of the standardized load being applied to the pneumatic tire 1 in the standardized state. The center position in the tire axial direction between the pair of tread ends Te can be the tire equator C.

In a case where a standard system including a standard on which the pneumatic tire 1 is based is provided, the terminology “standardized load” can refer to a load that is defined by the standard for each tire, and can be “maximum load capacity” in the JATMA standard, the maximum value recited in the table “TIRE LOAD LIMITS AT VARIOUS COLD INFLATION PRESSURES” in the TRA standard, or “LOAD CAPACITY” in the ETRTO standard, as examples. In a case where a standard system including a standard on which the pneumatic tire 1 is based is not provided, the terminology “standardized load” can refer to a load defined for each tire by a manufacturer or the like as the maximum load that can be applied when the pneumatic tire 1 is used.

The protector 8 can extend inward from the tread end Te in the tire radial direction, for example. The protector 8 may, for example, have a shape continuously extending from the tread pattern of the ground contact surface 2s. However, the protector 8 according to one or more embodiments of the present disclosure is not limited to such a structure. The protector 8 may be provided at any position of the sidewall portion 3 as long as at least a part of the protector 8 is provided on the buttress portion 3a.

A ratio DH/SH of a height DH of the protector 8 in the tire radial direction to the cross-sectional height SH can be 30% to 50%, as an example. Since the ratio DH/SH can be 30% or more, for instance, contact between a curbstone and the sidewall portion 3 can be reliably reduced even during application of a load, which can result in improvement in cut resistance of the pneumatic tire 1. Since the ratio DH/SH can be 50% or less, excessive increase in side stiffness can be inhibited, for instance, so that the pneumatic tire 1 can achieve both cut resistance and ride comfort.

The product (DH/SH)×PH×Hs of the ratio DH/SH, the protrusion height PH (mm) of the protector 8, and a hardness Hs of the tread rubber 2G can be 34 to 201, as an example. Here, the hardness Hs of the tread rubber 2G can be regarded as a durometer hardness as measured by using a type A durometer in accordance with JIS-K6253 in an environment of 23° C.

The pneumatic tire 1 having such a structure can be designed so as to reduce the hardness Hs of the tread rubber 2G in a case where the height DH and the protrusion height PH of the protector 8 are relatively large and side stiffness tends to be high, for instance, so that the pneumatic tire 1 can achieve both cut resistance and ride comfort.

The outer diameter SD of the pneumatic tire 1 can be 350 to 600 mm, as an example. Since the outer diameter SD of the pneumatic tire 1 can be 350 mm or more, for instance, a space can be ensured inside the rim. Since the outer diameter SD of the pneumatic tire 1 can be 600 mm or less, for instance, a contribution to increase in space in a vehicle such as a small bus or a low-floor electric vehicle can be made.

The cross-sectional width SW of the pneumatic tire 1 can be 145 to 285 mm, as an example. Since the cross-sectional width SW can be 145 mm or more, for instance, a large volume of the tire inner cavity can be ensured, whereby a contribution to improvement in ride comfort can be made by the pneumatic tire 1. Since the cross-sectional width SW can be 285 mm or less, for instance, excessive increase in tire weight can be inhibited, whereby the pneumatic tire 1 can maintain high ride comfort.

The rim width RW of the rim R can be 9 inches or less, as an example. In the pneumatic tire 1 having such a structure, excessive increase in rim weight can be inhibited, which can contribute to maintaining high ride comfort.

According to one or more embodiments of the present disclosure, the carcass 6 can include at least two carcass plies 6A and 6B. The carcass 6 having such a structure can allow exhibition of strength suitable for bearing a heavy load of a small bus, a low-floor electric vehicle, or the like.

The at least two carcass plies 6A and 6B can include, in the tread portion 2, a first carcass ply 6A located on an inner side in the tire radial direction, and a second carcass ply 6B located outward of the first carcass ply 6A in the tire radial direction, for example.

At least one of the carcass plies 6A and 6B can include a body portion 6a extending from the tread portion 2 to the bead cores 5 of the pair of bead portions 4 through the pair of sidewall portions 3, and a pair of turned-up portions 6b continuous to the body portion 6a. Each of the pair of turned-up portions 6b can be, for example, a portion turned up around a corresponding one of the pair of the bead cores 5 from the inner side to the outer side in the tire axial direction.

According to one or more embodiments of the present disclosure, the first carcass ply 6A and the second carcass ply 6B can each include the body portion 6a and the turned-up portions 6b. The first carcass ply 6A and the second carcass ply 6B having such a structure can improve side strength by the respective turned-up portions 6b, and can thus be suitable for bearing a heavy load of a small bus, a low-floor electric vehicle, or the like.

An outer end 6e, in the tire radial direction, of each of the turned-up portions 6b of the first carcass ply 6A can be, for example, located tire-radially outward of an outer end 6e, in the tire radial direction, of the corresponding one of the pair of turned-up portions 6b of the second carcass ply 6B. The carcass plies 6A and 6B having such a structure can allow stress at the respective outer ends 6e to be dispersed, which can reduce damage originating from the outer ends 6e.

According to one or more embodiments of the present disclosure, the outer end 6e of the turned-up portion 6b of the first carcass ply 6A can be located outward of the tire maximum width position P in the tire radial direction, and the outer end 6e of the turned-up portion 6b of the second carcass ply 6B can be located inward of the tire maximum width position P in the tire radial direction. The carcass 6 having such a structure can allow achievement of both stiffness and weight reduction of the sidewall portions 3, whereby a contribution to improvement in ride comfort can be made by the pneumatic tire 1 as a wide, small-diameter tire capable of bearing a heavy load.

The carcass plies 6A and 6B can include carcass cords formed of organic fiber cords, for example. Examples of the organic fiber cord can include a cord formed of a single kind of fiber selected from the group consisting of polyethylene terephthalate fiber, polyethylene naphthalate fiber, nylon fiber, aramid fiber, and rayon fiber, and a hybrid fiber cord formed of two or more kinds of fibers selected therefrom.

The carcass cords can be arranged at an angle of 25 to 90°, as an example, with respect to the tire circumferential direction. Here, the angle of the carcass cords can be an angle thereof in the pneumatic tire 1 in the standardized state, and can be, for example, checked by partially peeling the tread portion 2.

In a case where the carcass cords are inclined at an angle of less than 90° with respect to the tire circumferential direction, the carcass cords of the first carcass ply 6A and the carcass cords of the second carcass ply 6B may be inclined in opposite directions with respect to the tire circumferential direction. For the carcass 6, a bias structure may, for example, be employed.

The belt layer 7 can include at least one belt ply, for instance, two or more belt plies. According to one or more embodiments of the present disclosure, the belt layer 7 can include or consist of two belt plies 7A and 7B. The two belt plies 7A and 7B can include, for example, a first belt ply 7A located on an inner side in the tire radial direction, and a second belt ply 7B located outward of the first belt ply 7A in the tire radial direction. The belt layer 7 having such a structure can improve stiffness of the tread portion 2, and can be suitable for bearing a heavy load.

The belt plies 7A and 7B can include belt cords formed of steel cords, for example. The belt cord may, for example, be a single steel cord, or a strand obtained by stranding a plurality of steel filaments together.

The belt cords can be arranged at an angle of 10 to 30°, for instance, with respect to the tire circumferential direction, for example. The belt cords of the first belt ply 7A and the belt cords of the second belt ply 7B may be inclined in opposite directions with respect to the tire circumferential direction.

The belt layer 7 having such a structure can increase stiffness of the tread portion 2 in a well-balanced manner, and can allow the pneumatic tire 1 to achieve both ride comfort and stiffness for bearing a heavy load. Here, the angle of the belt cord can be an angle thereof in the pneumatic tire 1 in the standardized state, and can be, for example, checked by partially peeling the tread portion 2.

Although various embodiments of the present disclosure have been described above in detail, one or more embodiments of the present disclosure are not limited to the above-described embodiment, and various modifications can be made.

### Examples

Pneumatic tires having the basic structure illustrated in FIG. 1 were produced as test tires based on the specifications indicated in Table 1. The pneumatic tires produced as the test tires were evaluated in terms of cut resistance and ride comfort. Main common specifications and test methods are as described below.

### <Common Specifications>

Tire size: 205/40R15
Rim size: 15×7.0J
Air pressure: 350 kPa
Test vehicle: small bus

### <Cut Resistance>

A test vehicle on which the pneumatic tire produced as the test tire was mounted was caused to run at a certain angle with respect to a curbstone. Damage to the pneumatic tire and a wheel was visually evaluated after a side surface of the pneumatic tire was brought into contact with the curbstone 10 times. The result was represented by an index with the index of the comparative example being 100. The greater the value was, the better the cut resistance was.

### <Ride Comfort>

A test driver sat in a test vehicle on which the pneumatic tire produced as the test tire was mounted, and drove the test vehicle on a paved road surface in a test course. At this time, sensory evaluation was made by the test driver for ride comfort. The result was represented by an index with the index of the comparative example being 100. The greater the value was, the better the ride comfort was. It is confirmed that, when the index is 80 or more in the evaluation for ride comfort, the ride comfort is evaluated as being generally good on the market.

The test results are indicated in Table 1.

TABLE 1

| | Comp. | | | | | |
|---|---|---|---|---|---|---|
| | Ex. | Ex. 1 | Ex. 2 | Ex. 3 | Ex. 4 | Ex. 5 |
| Ratio DH/SH (%) of height | 0 | 40 | 40 | 30 | 50 | 50 |
| DH of protector to cross- | | | | | | |
| sectional height SH | | | | | | |
| Protrusion height PH (mm) | 0 | 2 | 6 | 2 | 6 | 6 |
| of protector 8 | | | | | | |
| Hardness Hs of tread rubber | 64 | 64 | 64 | 57 | 57 | 67 |
| Product (DH/SH) × | 0 | 51.2 | 153.6 | 34.2 | 171 | 201 |
| PH × Hs | | | | | | |
| Cut resistance (index) | 100 | 110 | 125 | 105 | 130 | 130 |
| Ride comfort (index) | 100 | 95 | 90 | 105 | 95 | 85 |
| Overall performance | 200 | 205 | 215 | 210 | 225 | 215 |
| (index) | | | | | | |

According to the test results, it was confirmed that the pneumatic tires of the examples had improved cut resistance as compared with the comparative example. It was also confirmed that the pneumatic tires of the examples were sufficiently marketable in terms of ride comfort. Furthermore, the pneumatic tires of the examples were also excellent in overall performance that was evaluated based on the total of cut resistance and ride comfort as compared with the comparative example. Therefore, it was confirmed that the pneumatic tires of the examples achieved both cut resistance and ride comfort.

### Additional Note

One or more embodiments of the present disclosure can be or include the following.

### Present Disclosure 1

A pneumatic tire that is mounted and used on a rim, the pneumatic tire including:
a tread portion having a ground contact surface; and
a pair of sidewall portions extending inward in a tire radial direction from both sides of the tread portion in a tire axial direction, in which
the rim has a rim diameter RD of 10 to 18 inches,
the rim has a rim width RW that is 78% to 99% of a cross-sectional width SW of the tire,
a ratio SH/SW of a cross-sectional height SH of the tire to the cross-sectional width SW is 30% to 45%,
each of the pair of sidewall portions has a buttress portion located on an outer side in the tire radial direction, and
a protector protruding outward in the tire axial direction is disposed on at least one of a pair of the buttress portions.

### Present Disclosure 2

The pneumatic tire according to present disclosure 1, wherein
the protector has an outer end located outward, in the tire axial direction, of a tire maximum width position on each of the sidewall portions excluding the protector.

### Present Disclosure 3

The pneumatic tire according to present disclosure 1 or 2, wherein
the protector is provided on each of the pair of the buttress portions.

### Present Disclosure 4

The pneumatic tire according to any one of present disclosures 1 to 3, wherein
a total width PW of the tire between a pair of the outer ends is 105% to 115% of the cross-sectional width SW.

### Present Disclosure 5

The pneumatic tire according to any one of present disclosures 1 to 4, wherein
a ratio DH/SH of a height DH of the protector in the tire radial direction to the cross-sectional height SH is 30% to 50%.

### Present Disclosure 6

The pneumatic tire according to any one of present disclosures 1 to 5, wherein
the tread portion includes tread rubber forming the ground contact surface, and
a product (DH/SH)×PH×Hs of the ratio DH/SH, a protrusion height PH (mm) of the protector, and a hardness Hs of the tread rubber is 34 to 201.

### Present Disclosure 7

The pneumatic tire according to any one of present disclosures 1 to 6, wherein
the protector has the protrusion height PH of 2.0 to 6.0 mm.

### Present Disclosure 8

The pneumatic tire according to any one of present disclosures 1 to 7, wherein
the pneumatic tire includes a carcass extending from the tread portion to a bead portion located inward of each of the pair of sidewall portions in the tire radial direction, and the carcass includes at least two carcass plies.

### Present Disclosure 9

The pneumatic tire according to any one of present disclosures 1 to 8, wherein
the at least two carcass plies include, in the tread portion, a first carcass ply located on an inner side in the tire radial direction, and a second carcass ply located outward of the first carcass ply in the tire radial direction, and
each of the first carcass ply and the second carcass ply includes a body portion extending from the tread portion to bead cores of a pair of the bead portions through the pair of sidewall portions, and a pair of turned-up portions continuous to the body portion, the turned-up portions being turned up around a pair of the bead cores, respectively, from an inner side to an outer side in the tire axial direction.

### Present Disclosure 10

The pneumatic tire according to any one of present disclosures 1 to 9, wherein
an outer end, in the tire radial direction, of each of the pair of turned-up portions of the first carcass ply is located outward of an outer end, in the tire radial direction, of the corresponding one of the pair of turned-up portions of the second carcass ply, in the tire radial direction.

### Present Disclosure 11

The pneumatic tire according to any one of present disclosures 1 to 10, wherein
an outer diameter of the tire is 350 mm to 600 mm,
the cross-sectional width SW of the tire is 145 mm to 285 mm, and
the rim width RW is 9 inches or less.

### Present Disclosure 12

The pneumatic tire according to any one of present disclosures 1 to 11, further comprising a carcass extending from the tread portion to a bead portion inward of each sidewall portion of the pair of sidewall portions in the tire radial direction, wherein
a plurality of carcass plies of the carcass each have a turned-up portion with an outer end, and
the outer end of each of the turned-up portions is inward, in the tire radial direction, of the protector.

### Present Disclosure 13

The pneumatic tire according to any one of present disclosures 1 to 12, further comprising a carcass extending from the tread portion to a bead portion inward of each sidewall portion of the pair of sidewall portions in the tire radial direction, wherein
a first carcass ply and a second carcass ply of the carcass each have a turned-up portion with an outer end, and
an outer end of the turned-up portion for the first carcass ply is outward, in the tire radial direction, of a tire maximum width position, and
an outer end of the turned-up portion for the second carcass ply is inward, in the tire radial direction, of the tire maximum width position.

### Present Disclosure 14

A pneumatic tire that is mountable and usable on a rim, the pneumatic tire comprising:
a tread portion having a ground contact surface;
a pair of sidewall portions extending inward in a tire radial direction from both sides of the tread portion in a tire axial direction; and
a carcass extending from the tread portion to a bead portion inward of each sidewall portion of the pair of sidewall portions in the tire radial direction, wherein
the rim has a rim diameter of 10 to 18 inches,
the rim has a rim width that is 78% to 99% of a cross-sectional width of the tire,
a ratio of a cross-sectional height of the tire to the cross-sectional width of the tire is 30% to 45%,
each sidewall portion of the pair of sidewall portions has a buttress portion on an outer side in the tire radial direction relative to a tire maximum width position on the sidewall portion,
a protector protruding outward in the tire axial direction is on at least one of the buttress portions of the pair of sidewall portions,
the protector has an outer end located outward, in the tire axial direction, of the tire maximum width position on each of the sidewall portions excluding the protector,
a plurality of carcass plies of the carcass each have a turned-up portion with an outer end, and
the outer end of each of the turned-up portions is inward, in the tire radial direction, of the protector.

### Present Disclosure 15

The pneumatic tire according to present disclosure 14, wherein the protector is on each of the buttress portions of each of the sidewall portions of the pair of sidewall portions.

### Present Disclosure 16

The pneumatic tire according to present disclosure 14 or 15, wherein a total width of the tire between a pair of the outer ends is 105% to 115% of the cross-sectional width of the tire.

### Present Disclosure 17

The pneumatic tire according to any one of present disclosures 14 to 16, wherein the protector has a protrusion height of 2.0 to 6.0 mm.

### Present Disclosure 18

The pneumatic tire according to any one of present disclosures 14 to 17, wherein
an outer end of the turned-up portion for the first carcass ply is outward, in the tire radial direction, of a tire maximum width position, and
an outer end of the turned-up portion for the second carcass ply is inward, in the tire radial direction, of the tire maximum width position.

### Present Disclosure 19

The pneumatic tire according to any one of present disclosures 14 to 18, wherein
an outer diameter of the tire is 350 mm to 600 mm,
the cross-sectional width of the tire is 145 mm to 285 mm, and
the rim width is 9 inches or less.

What is claimed is:

1. A pneumatic tire that is mountable and usable on a rim, the pneumatic tire comprising:
a tread portion having a ground contact surface; and
a pair of sidewall portions extending inward in a tire radial direction from both sides of the tread portion in a tire axial direction, wherein
the rim has a rim diameter RD of 10 to 18 inches,
the rim has a rim width RW that is 78% to 99% of a cross-sectional width SW of the tire,
a ratio SH/SW of a cross-sectional height SH of the tire to the cross-sectional width SW is 30% to 45%,
each sidewall portion of the pair of sidewall portions has a buttress portion on an outer side in the tire radial direction, and
a protector protruding outward in the tire axial direction is on at least one of the buttress portions of the pair of sidewall portions.

2. The pneumatic tire according to claim 1, wherein the protector has an outer end located outward, in the tire axial direction, of a tire maximum width position on each of the sidewall portions excluding the protector.

3. The pneumatic tire according to claim 2, wherein the protector is on each of the buttress portions of the sidewall portions of the pair of sidewall portions.

4. The pneumatic tire according to claim 3, wherein a total width PW of the tire between a pair of the outer ends is 105% to 115% of the cross-sectional width SW of the tire.

5. The pneumatic tire according to claim 1, wherein a ratio DH/SH of a height DH of the protector in the tire radial direction to the cross-sectional height SH of the tire is 30% to 50%.

6. The pneumatic tire according to claim 5, wherein
the tread portion includes tread rubber forming the ground contact surface, and
a product (DH/SH)×PH×Hs of the ratio DH/SH, a protrusion height PH (mm) of the protector, and a hardness Hs of the tread rubber is 34 to 201.

7. The pneumatic tire according to claim 1, wherein the protector has a protrusion height PH of 2.0 to 6.0 mm.

8. The pneumatic tire according to claim 1, wherein
the pneumatic tire includes a carcass extending from the tread portion to a bead portion inward of each sidewall portion of the pair of sidewall portions in the tire radial direction, and
the carcass includes at least two carcass plies.

9. The pneumatic tire according to claim 8, wherein
the at least two carcass plies include, in the tread portion, a first carcass ply on an inner side in the tire radial direction, and a second carcass ply outward of the first carcass ply in the tire radial direction, and
each of the first carcass ply and the second carcass ply includes a body portion extending from the tread portion to bead cores of a pair of the bead portions through the pair of sidewall portions, and a pair of turned-up portions continuous to the body portion, the turned-up portions being turned up around a pair of the bead cores, respectively, from an inner side to an outer side in the tire axial direction.

10. The pneumatic tire according to claim 9, wherein an outer end, in the tire radial direction, of each of the pair of turned-up portions of the first carcass ply is outward of an outer end, in the tire radial direction, of the corresponding one of the pair of turned-up portions of the second carcass ply, in the tire radial direction.

11. The pneumatic tire according to claim 1, wherein
an outer diameter of the tire is 350 mm to 600 mm,
the cross-sectional width SW of the tire is 145 mm to 285 mm, and
the rim width RW is 9 inches or less.

12. The pneumatic tire according to claim 1, further comprising a carcass extending from the tread portion to a bead portion inward of each sidewall portion of the pair of sidewall portions in the tire radial direction, wherein
a plurality of carcass plies of the carcass each have a turned-up portion with an outer end, and
the outer end of each of the turned-up portions is inward, in the tire radial direction, of the protector.

13. The pneumatic tire according to claim 1, further comprising a carcass extending from the tread portion to a bead portion inward of each sidewall portion of the pair of sidewall portions in the tire radial direction, wherein
a first carcass ply and a second carcass ply of the carcass each have a turned-up portion with an outer end, and
an outer end of the turned-up portion for the first carcass ply is outward, in the tire radial direction, of a tire maximum width position, and
an outer end of the turned-up portion for the second carcass ply is inward, in the tire radial direction, of the tire maximum width position.

14. A pneumatic tire that is mountable and usable on a rim, the pneumatic tire comprising:
a tread portion having a ground contact surface;
a pair of sidewall portions extending inward in a tire radial direction from both sides of the tread portion in a tire axial direction; and
a carcass extending from the tread portion to a bead portion inward of each sidewall portion of the pair of sidewall portions in the tire radial direction, wherein
the rim has a rim diameter of 10 to 18 inches,
the rim has a rim width that is 78% to 99% of a cross-sectional width of the tire,
a ratio of a cross-sectional height of the tire to the cross-sectional width of the tire is 30% to 45%,
each sidewall portion of the pair of sidewall portions has a buttress portion on an outer side in the tire radial direction relative to a tire maximum width position on the sidewall portion,
a protector protruding outward in the tire axial direction is on at least one of the buttress portions of the pair of sidewall portions,
the protector has an outer end located outward, in the tire axial direction, of the tire maximum width position on each of the sidewall portions excluding the protector,
a plurality of carcass plies of the carcass each have a turned-up portion with an outer end, and
the outer end of each of the turned-up portions is inward, in the tire radial direction, of the protector.

15. The pneumatic tire according to claim 14, wherein the protector is on each of the buttress portions of each of the sidewall portions of the pair of sidewall portions.

16. The pneumatic tire according to claim 14, wherein a total width of the tire between a pair of the outer ends is 105% to 115% of the cross-sectional width of the tire.

17. The pneumatic tire according to claim 14, wherein the protector has a protrusion height of 2.0 to 6.0 mm.

18. The pneumatic tire according to claim 14, wherein
an outer end of the turned-up portion for the first carcass ply is outward, in the tire radial direction, of a tire maximum width position, and
an outer end of the turned-up portion for the second carcass ply is inward, in the tire radial direction, of the tire maximum width position.

19. The pneumatic tire according to claim 14, wherein
an outer diameter of the tire is 350 mm to 600 mm,
the cross-sectional width of the tire is 145 mm to 285 mm, and
the rim width is 9 inches or less.
